(19) United States
(12) Patent Application Publication
(10) Pub. No.: US 2004/0120286 A1
(43) Pub. Date: Jun. 24, 2004

(54) Transmission method, system and radio network controller

(76) Inventor: Uwe Schwarz, Veikkola (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/326,282

(22) Filed: Dec. 23, 2002

(51) Int. Cl. H04Q 7/00

(52) U.S. Cl. 370/331

(57) ABSTRACT

A radio network controller, comprising: means for storing information on the loads of cells in a first network, means for storing information on the loads of cells in a second network, means for choosing a cell in the second network as a handover target cell, means for giving a handover trigger, means for controlling a handover from the network to which the radio network controller belongs to a different network.

### BACKGROUND OF THE INVENTION

1. Field of the Invention

The invention relates to a data transmission method in a telecommunication system a radio system, a radio network controller.

1. Description of the Related Art

The increase of transmission in coreless networks continues also in the future; consumers have already accustomed to communicating when they want and where they want. Also the quality of services is becoming more and more important. One answer to the requirements of clients and future challenges is a Common radio Resource Management (CRRM) concept. The CRRM enables unified radio bearer QoS (Quality of Service) management over the network both for load sharing and congestion control, for instance.

However, it is not always possible for operators to build networks fast enough when the capacity demand increases and sometimes it is not even cost-effective to build a network according to the highest capacity need, especially when the capacity peak does not occur frequently.

An increasing use of a radio network may lead to a situation where the network is congested or it probably will be congested. The situation can even become worse if there are numerous of soft handovers, which reserve capacity. The problem is that the risk of dropped calls increases.

### SUMMARY OF THE INVENTION

It is an object of the invention to provide a method and an arrangement to prevent calls from being dropped. This is achieved by a data transmission method in a telecommunication system, the system comprising at least two radio networks and at least one user terminal, the method comprising a user terminal being served in a cell of a first network, if the neighboring cells of the serving cell in the first network are congested, choosing a cell in a second network as a handover target cell, performing a handover from the first network to the second network.

The invention also relates to a data transmission method in a telecommunication system, the system comprising at least two radio networks and at least one user terminal, the method comprising, a user terminal being served in a cell of a first network, measuring neighboring cells of a subscriber's serving cell belonging to the first network and to a second network and storing the measurement information, storing information on the loads of neighboring cells of a subscriber's serving cell belonging to the first network, storing information on the loads of neighboring cells of a subscriber's serving cell belonging to the second network, if the neighboring cells of the serving cell in the first network are congested, choosing a cell in the second network as a handover target cell, giving a handover trigger, performing a handover from the first network to a determined cell of the second network.

The invention also relates to a telecommunication system, the system comprising at least two radio networks and at least one user terminal, the system further comprising, a user terminal being served in a cell of a first network, means for detecting the loads of cells in the first network, means for detecting the loads of cells in a second network, means for choosing a cell in the second network as a handover target cell, means for performing a handover from the first network to the second network.

The invention also relates to a telecommunication system, the system comprising at least two radio networks and at least one user terminal, the system further comprising, a user terminal being served in a cell of the first network, means for measuring on neighboring cells of a subscriber's serving cell belonging to a first operator's network means for measuring on neighboring cells of a subscriber's serving cell belonging to a second operator's network, means for detecting the loads of cells in the first network, means for detecting the loads of cells in the second network, means for choosing a cell in the second network as a handover target cell, means for giving a handover trigger, means for performing a handover from the first network to a determined cell of the second network.

The invention also relates to a radio network controller comprising: means for storing information on the loads of cells in a first network, means for storing the information on loads of cells in a second network, means for choosing as a handover target cell a cell in the second network, means for controlling a handover from the network to which the radio network controller belongs to a different network.

The invention also relates to a radio network controller, comprising: means for storing information on the loads of cells in a first network, means for storing the information on loads of cells in a second network, means for choosing a cell in the second network as a handover target cell, means for giving a handover trigger, means for controlling a handover from the network to which the radio network controller belongs to a different network.

Preferred embodiments of the invention are described in the dependent claims.

The method and system of the invention provide several advantages. In a preferred embodiment of the invention, it is possible to transfer a call to another operator's network and thus diminish the probability of calls being dropped.

### BRIEF DESCRIPTION OF THE DRAWINGS

In the following, the invention will be described in greater detail with reference to the preferred embodiments and the accompanying drawings, in which

FIG. 1 illustrates an example of a general protocol model for a radio access system;

FIG. 2 shows an example of a radio system;

FIG. 3 is a flow chart;

FIG. 4 is another flow chart, and

FIG. 5 shows an example of a radio network controller.

### DETAILED DESCRIPTION OF THE PREFERRED EMBODIMENTS

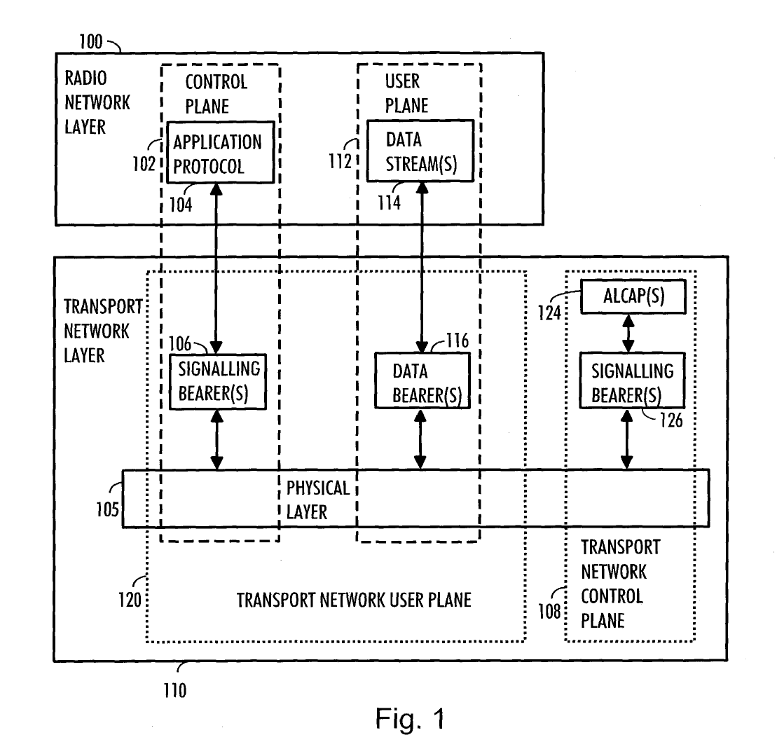

With reference to FIG. 1, examine an example of a general protocol model for a radio access system, using the UTRAN as an example. Similarly, a protocol model for other radio access networks, such as IP RAN, could be described. UTRAN's internal functions and protocols can be classified into two horizontal layers: a radio network layer (RNL) 100, and a transport network layer 110. In the vertical direction the protocol model comprises three planes, a (radio network) control plane 102, a (radio network) user plane 112 and a transport network control plane 108. The control plane 102 and the user plane 112 of the radio network layer 100 are conveyed via the transport network layer using the transport network user plane 120.

Application protocols 104 and data streams 114 in the radio network layer 100, and signalling bearers 106, data bearers 116, and a physical layer 105 in the transport network user plane 120 of the transport network layer 110 are illustrated. Signalling bearers 126 and an access link control application protocol (ALCAP) 124 in the transport network control plane 108 of the transport. network layer 110 are also illustrated in FIG. 1.

The control plane 102 transfers signalling information, and the user plane 112 transfers all information sent and received by the user. The radio network layer 100 includes all the functions and protocols related to radio, i.e. RAN, or cellular specific protocols. The transport network layer 110 represents standard transport technology selected to be used for the RAN, e.g. IP or ATM (asynchronous transfer mode) in the UTRAN or IP in IP RAN. In the transport network layer 110, the signalling bearer is always set up by operation and management actions (O&M). The signalling protocol for ALCAP 124 may be of the same type as the signalling protocol for the application protocol 104, or it may be of a different type. When the signalling bearers have been provided, the application protocol 202 in the radio network layer 100 may ask for data bearers 116 to be set up by the ALCAP 124, which has all the required information about the user plane technology. Preconfigured data bearers can also be used, likewise the lu interface of the packet-switched side, in which case no ALCAP 124, and therefore neither a signalling bearer 126 nor the transport network control plane 108, is needed.

Each layer of the protocol model can be described in terms of logical entities. One physical network element may include more than one logical entity for each layer. Further information on radio telecommunications systems can be found in the literature and standards in the field.

Next, principles of handovers will be explained in further detail.

There are several reasons for activating a handover. The basic reason for a handover is that the radio connection no longer fulfills set criteria, such as signal quality, user mobility or traffic distribution. A signal quality handover is carried out when the quality of the radio signal deteriorates below defined limits. Signal changes are detected by measurements carried out by user equipment or base stations.

A traffic distribution handover occurs when the traffic capacity of a cell has reached the maximum or is approaching it. In such a situation, user equipment near the edge of the cell with a high load may be transferred to a neighbouring cell with a smaller load.

The corresponding multiple access system determines which air interface resources are to be shared with users and, therefore, how the handover is carried out. In other words, the multiple access system determines which characteristic defines a channel. For example, in code division multiple access systems a user, when carrying out a handover, is provided with a new code, in time division multiple access systems a new time slot, and in frequency division systems a new frequency. There are also hybrid systems where a user may be provided, for instance, both a new code and a new time slot.

Handovers (HO) are typically categorised as hard handovers (HHO), soft handovers (SHO) and softer handovers. In a hard handover, the old radio connection, typically between user equipment and a base station (called also for instance a B-node), is released before a new connection is accomplished. In an inter-frequency hard handover, the carrier frequency of the new radio access connection is different from the old carrier frequency, and in an intra-frequency handover, it is the same as the old carrier. An inter-frequency handover can be accomplished if different carriers are allocated to different network cells. Furthermore, inter-frequency handovers may take place between two different types of radio access networks, for example between the UTRAN and GSM or between the IP RAN and GSM, because different systems usually utilize different frequency bands. These handovers can also be called inter-system handovers, or inter-RAT (radio access technology) handovers. It should be noticed that Inter-system handovers are possible only if they are completely supported by the user equipment as well.

In a soft handover, the user equipment establishes a new connection to the network before the old connection is released. The UE (user equipment) collects measurement information in an active set, which is a list of base stations the UE is able to hear, or more specifically, radio cells through which the UE has a simultaneous connection to the RAN, for instance the UTRAN or the IP RAN. In other words, the active set is a list of cells into which the UE is able to perform a handover. For example, in WCDMA systems most handovers are intra-frequency soft handovers where the neighboring base stations involved in the handover transmit using the same frequency. A soft handover is performed between two radio cells that belong to different base stations. However e.g. in the UTRAN the cells do not necessarily belong to the same RNC, but the RNC involved in the soft handover is responsible for coordinating the execution of the soft handover over the lur interface. The simultaneous connections between the UE and the network are called soft handover legs (SHO leg). A soft handover leg is a connection comprising a radio connection between the UE and a base station and a possible transport connection between the base station and a serving network element that routes the connection of the UE via the serving network element to the core network.

There are also several variations of soft handovers, e.g. softer and soft-softer handovers. In a softer handover, a new signal is either added to or deleted from the active set, or replaced by a stronger signal of another sector of the same base station. The term ‘soft-softer handover’ is often used when a soft and a softer handover occur simultaneously.

A basic handover process typically comprises three main phases: a measurement, a reporting and a handover phase.

Cells to be measured can be divided into three different cell sets: an active, a monitored and a detected set. Each set performs measurements in the cells according to their own requirements.

UE measurements may, for example, comprise intra-frequency measurements (signals with the same frequencies), such as signal strength of downlink physical channels, traffic volume measurements, quality measurements, such as downlink transport block error rate, and internal measurements, such as user equipment transmission power and user equipment received signal level. The UE measurements may be triggered on the basis of several criteria, such as changes in the signal-to-interference ratio (SIR), periodical reporting, time-to-trigger or changes in the primary common pilot channel (CPICH) signal level.

UE collects measurement information in the active set. When the transmission signal strength of a BTS exceeds the predetermined threshold in the UE, the BTS is added to the active set. The UE does not add or remove base stations in its active set independently, but the network requests modifications for the active set through signalling.

Measurement results reported by the UE or a the BTS and the criteria set by the selected handover algorithm form a basis for a handover decision-making. The handover algorithms are not standardised, but more of an implementation-dependent type and capable of being used rather freely. The handover algorithms are known to those skilled in the art and therefore will not be explained in greater detail here.

The RRC (radio resource control) layer is responsible for maintaining the connection between UE and the network when the UE moves from one cell to another. A handover decision is made in the RAN RRC (radio access network RRC).

Since radio resources are expensive, the radio related part of the radio access network tries to optimize their utilisation. There are many methods available for the controlling function of all of the radio related control. For example, an entity called a common resource management server (CRMS) can be used for the management of radio resource control. In this application, the term ‘radio manager’ (RM) is used for the controlling function of all of the radio related control.

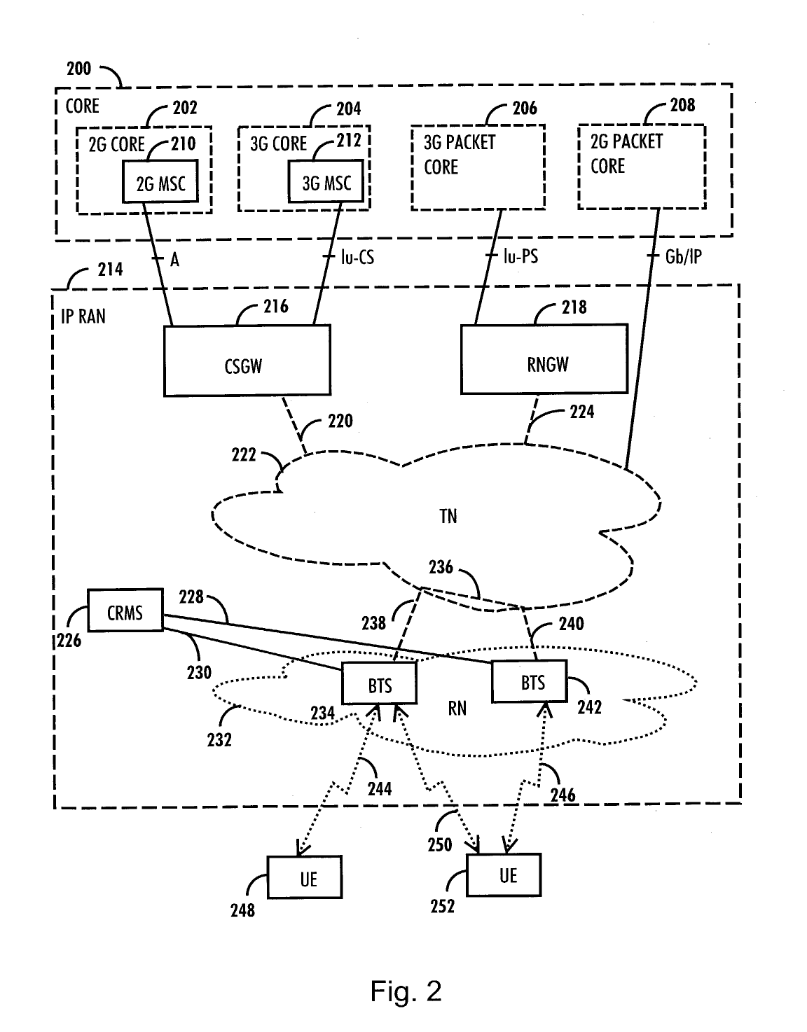

FIG. 2, to which reference is now made, illustrates an example of a radio network in which the invention can be implemented. The embodiment is described in a simplified radio system, using an IP RAN (internet protocol radio access network) based system as an example. However, the embodiments are not restricted to the systems given as examples, but a person skilled in the art may apply the solution to other radio systems or their combinations provided with necessary properties.

The radio system of FIG. 2 comprises a radio access network, in this case an IP RAN 214, but the radio access network could also be for example an UTRAN network.

The radio system comprises at least one unit of user equipment 248, 252. The IP RAN of FIG. 2 comprises a radio network RN 232 for providing a telecommunications connection to the user equipment and a transport network TN 222 for connecting the network elements of the radio network and connecting the radio network to the core network 200 of the radio system.

The telecommunication connections are established by the user equipment and base stations which communicate with each other on a radio connection, i.e. calls or data transmission connections between different UE are established via base stations. The radio coverage area formed by a BTS is usually called a cell. The radio cells created by base stations usually overlap to some extent to provide improved coverage. The radio network comprises base stations (called B-nodes in UTRAN) 234, 242, which, in the case of IP RAN, are IP base stations. The first base station 234 provides the user equipment 248 with a radio connection 244 and the second base station provides the user equipment with a radio connection 246. The first base station has a contact to transport network TN via a connection 238 and the second base station has a contact to a transport network TN via a connection 240. These connections are typically implemented by radio connections. Different base stations in a network communicate with each other. In this example, they communicate via a transport network which in FIG. 2 is marked with a line 236.

The logical function of the radio network is to provide the user equipment with a radio connection for transmission and reception. The logical function of the transport network is to provide the radio cell with a connection to the core network. It should be noted that one base station can accomplish several radio connections or cells but for the sake of clarity these are not described in FIG. 2.

FIG. 2 depicts a soft handover situation, where UE 252 has simultaneously a radio connection with a base station 242 and a radio connection 250 with a base station 234. Soft handovers are explained in greater detail above.

The IP RAN also comprises one or more radio access network gateways (RNGW) 218 that are access points to IP RAN from the core network and from other radio access networks. The radio access network may also comprise other gateways; for instance, a circuit switched gateway (CSGW) 216 which is for circuit switched traffic. The IP RAN can typically also comprise other RAN gateways, such as a radio access network server (RNAS, RAN access server) for controlling access to the radio access network. The transport network is connected via a connection 220 to the CSGW and via a connection 224 to the RNGW. Both connections are usually thought to be a part of the transport network.

The core network described in FIG. 2 may comprise core networks of different generations, such as a 2G core network 202, a 3G core network 204, a 3G packet core network 206 and a 2G packet core network 208. The 2G core network comprises a 2G mobile station controller (2G MSC) 210 connected via interface A to the CSGW. The 3G core network comprises a 3G mobile station controller (3G MSC) 212 connected via an lu-CS interface to the CSGW. The 3G packet core network is connected via an lu interface to the RNGW. The 2G packet core network, in turn, is connected via a Gp/IP interface to the transport network.[0045] One of the network elements of the radio network acts as a serving network element, in other words routes the telecommunications connection of the user equipment via the serving network element to the core network, i.e. it terminates the core network interfaces and RRC (radio resource control). One serving network element is provided for each UE that has a connection to the RAN. In the case of IP RAN, this serving network element is a serving base station (serving IP BTS), and in the case of UTRAN, a serving radio network controller (RNC). The radio network may also comprise a drifting network element which, in case of the IP RAN, is called a drifting IP BTS, and in the case of UTRAN, a drifting RNC. The role of the drifting network element is to provide the serving network element with radio resources for the UE connection, when the connection needs to use the cells controlled by the drifting network element. The serving and drifting network elements may change their location, i.e. a drifting network element may later act as a serving network element and vice versa.

In a radio system, a telecommunications connection of UE can be anchored to a network element, for example to a base station of the radio network. The term ‘anchoring’ can be used in IP RAN to describe a situation where the serving IP BTS functions are provided by a BTS not providing radio resources to the UE. In UTRAN, the term can be used to describe a situation where UE has no connections to any cell controlled by the serving RNC.

The radio system of FIG. 2 also comprises a radio resource management unit 226 for managing the radio resources between the base stations and the user equipment in the radio network. The radio resource management unit is configured to receive radio capacity information. The radio capacity information can be indicated as the cell load of the radio cell. In the example of FIG. 2, the radio resource management unit is implemented using a common radio resource management server (CRMS). The radio resource management server is connected to the base stations via the connections 228, 230. The CRRM (Common radio resource management) enables unified radio bearer QoS (Quality of Service) management over the network, load sharing and congestion control, for instance. It also facilitates operation in a multi-vendor environment and utilization of several cell layers (macro and micro cells).

However, the implementation of the embodiment is not restricted to the CRMS but the radio resource management unit could be any entity configured to receive radio capacity information on the radio network.

The disclosed functionalities can be implemented in the different parts of the radio system by means of software, usually as a processor and its software, but various hardware solutions are also feasible, e.g. a circuit built of logic components or one or more application specific integrated circuits ASIC. A hybrid of these different implementations is also feasible.

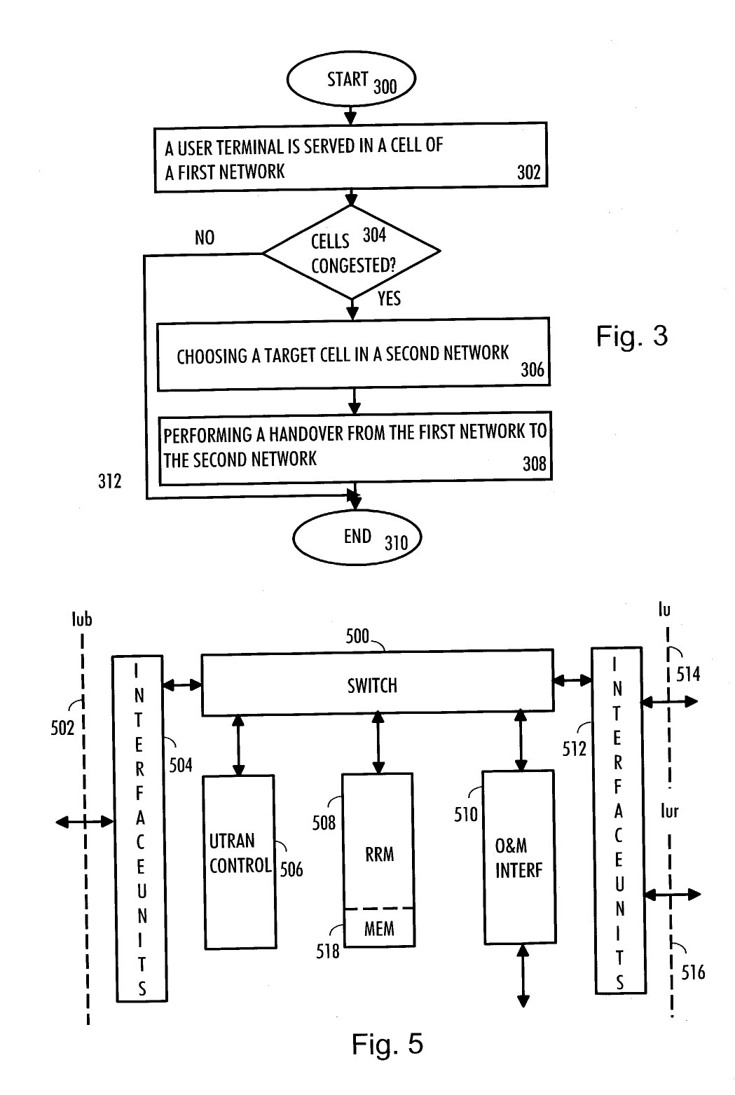

FIG. 3 is a flow chart illustrating a preferred embodiment of the invention. The method is implemented in at least two networks which, in a preferred embodiment, belong to different operators. The networks can use the same telecommunication system standard or they can use different standards. If telecommunication systems are different, the UE has to support them both to be able to perform a handover.

The method starts from block 300. In block 302, a user terminal (UE) is served in a serving cell that belongs to a first network.

Next, if the first operator's network finds out that there is or will be a congestion in the immediate future in block 304, that is to say all the neighboring cells of the first (serving) network are congested or about to be congested and there is free capacity in the other network, a cell in the second network is selected as a handover target cell in block 306. This is to prevent a call from dropping. A user can be transferred to the other network for instance just for a period of time and as soon as enough capacity is released, the user will be returned, or a user can be transferred to the other network until a there is a need for a handover. Then a handover from the first network to the second network is carried out in block 308. A handover between different operators' networks is here called a last exit handover.

There are several reasons for activating a handover. The basic reason for a handover is that the radio connection no longer fulfills set criteria, such as signal quality, user mobility or traffic distribution. A signal quality handover is carried out when the quality of the radio signal drops below defined limits. The deterioration is detected by signal measurements carried out by user equipment or base stations.

A traffic distribution handover occurs when the traffic capacity of a cell has reached the maximum or is approaching it. In such a situation, the user equipment near the edge of the cell with a high load may be transferred to a neighboring cell with a smaller load.

The handover algorithms are not standardize but more of an implementation-dependent type and capable of being used rather freely. The handover algorithms are known to those skilled in the art and therefore will not be explained in greater detail here. The method does not restrict the choosing of the handover algorithm.

It should be noted that handovers between networks of different operators usually require a contract between the operators.

The method ends in block 310. An arrow 312 depicts a situation where the cells of the subscriber's serving network are not congested.

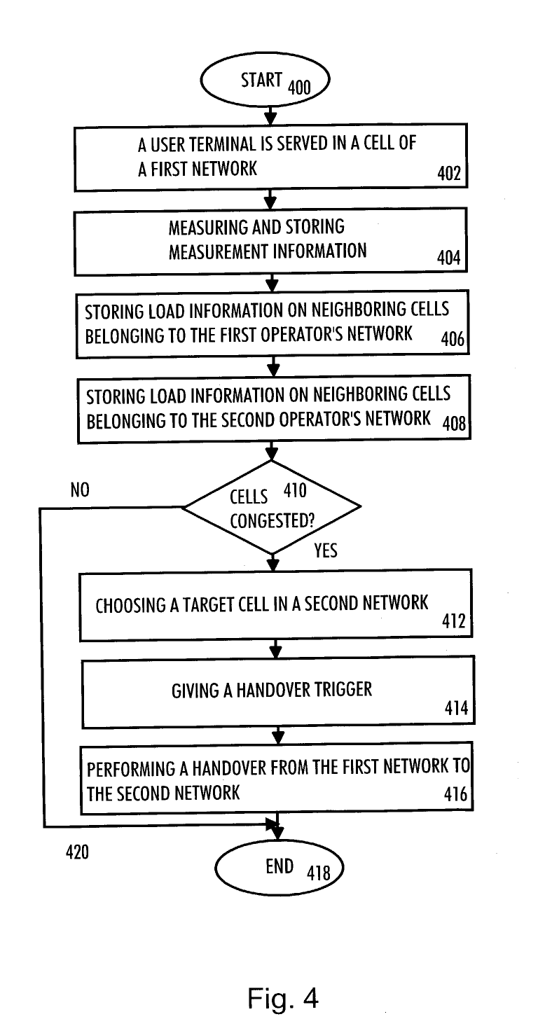

FIG. 4 illustrates a flow chart of another preferred embodiment of the invention. The method is implemented in at least two networks that, in a preferred embodiment, belong to different operators. The networks can use the same telecommunication system standard of they can use different standards. If the telecommunication systems are different, the UE has to support them both to be able to perform a handover.

The method starts from block 400. In block 402, a user terminal (UE) is served in a serving cell that belongs to a first network.

In block 404 neighboring cells of a subscriber's serving cell belonging to a first (serving) operator's network and of a second operator's network are measured. These measurements are preferably typical handover measurements, such as intra-frequency measurements, traffic volume measurements, quality measurements and internal measurements. These measurements are often made by user equipment or base stations. The UE measurement events may be triggered based on criteria such as a change of the best cell, changes in the signal-to-interference ratio (SIR), periodical reporting, time-to-trigger or changes in the primary common pilot channel (CPICH) signal level.

Measurement information is stored in a memory of a radio network controller or of another network element.

In block 406, information on the loads of neighboring cells of a subscriber's serving cell belonging to a first network is stored. The traffic load information is gathered to clarify the amount of unreserved capacity in the neighboring cells. The information is typically stored in a memory unit of a radio network controller, a base station or an entity responsible for similar activities. The entity, which is typically responsible for traffic load and related information, is often a common radio resource management server (CRRMS).

In block 408, information on the loads of neighboring cells of a subscriber's serving cell belonging to a second network is stored. This is to clarify the amount of unreserved capacity in the neighboring cells in the other operator's network. This can be implemented by signalling between the two networks involved. For instance, CRRMS units of both networks can communicate between each other.

Next, if the first network finds out that there is or will be a congestion in the immediate future in block 410, that is to say all the neighboring cells of the first network are congested or about to be congested and there is free capacity in the other network, a cell in the second network is selected as a handover target cell in block 412.

A suitable network element, for example a radio network controller, gives a handover trigger for carrying out a handover from the first network to the second network in block 414. The trigger can, for instance, be a message, such as “all own cells congested”.

In block 416, a handover is carried out from the first network to a determined cell of the second network.

The above-described handovers are carried out to prevent a call from dropping. A user can be transferred to the other network just for a period of time and, as soon as enough capacity is released in the previous network, the user will be returned, or a user can be transferred to the other network until a new handover is needed. A handover between different operators' networks is here called a last exit handover.

The method ends in block 418. An arrow 420 depicts a situation where the cells of the subscriber's serving network are not congested.

FIG. 5 shows a simplified functional example of a radio network controller (RNC) where the embodiments of the last exit handover method can be implemented. A radio network controller can also be called, for instance, a base station controller. It is clear for a person skilled in the art it is clear that a radio network controller can differ from what has been depicted in FIG. 5.

The RNC is, as mentioned above, the switching and controlling element of UTRAN. The UTRAN is the network element of the UMTS network. A switching unit 500 is responsible for the connection between the core network and the user equipment. The radio network controller is located between lub 502 and lu 514 interfaces. There is also an interface lur for inter-RNC transmission 516. Blocks 504 and 512 depict interface units between the radio network controller and another network. The precise implementation of the radio network controller is producer-dependent.

The functionality of the radio network controller can be divided into two classes: UTRAN radio resource management 508 and control functions 506. An operation and management interface function 510 serves as a medium for information transfer to and from network management functions. The radio resource management is a group of algorithms for sharing and managing the radio path connection to provide sufficient quality and capacity for the connection. The most important radio resource management algorithms are handover control, power control, admission control, packet scheduling, and code management. The UTRAN control functions are responsible for functions related to the set-up, maintenance and release of a radio connection between base stations and user equipment.

The radio network controller performs the actions needed in the embodiments of the handover method described above, such as giving a handover trigger. The functions required by the embodiments of the handover method are usually carried out in the radio resource management block 508. This process also requires a memory unit 518 where, for example, the load information is stored.

The disclosed functionalities of the described embodiments of the data transmission method can advantageously be implemented by means of software typically being located in the radio resource management block 508 of a radio network controller or in a corresponding network element, for example a base station in the case of IP RAN, and CRRM. The implementation solution can for instance also be an ASIC (Application Specific Integrated Circuit) component. A hybrid of these different implementations is also feasible.

Even though the invention has been described above with reference to an example according to the accompanying drawings, it is clear that the invention is not restricted thereto but can be modified in several ways within the scope of the appended claims.

We claim:

1. A data transmission method in a telecommunication system, the system comprising at least two radio networks and at least one user terminal, the method comprising,
a user terminal being served in a cell of a first network, if the neighboring cells of the serving cell in the first network are congested,
choosing a cell in a second network as a handover target cell,
performing a handover from the first network to the second network.

2. A data transmission method in a telecommunication system, the system comprising at least two radio networks and at least one user terminal, the method comprising,
a user terminal being served in a cell of a first network,
measuring neighboring cells of a subscriber's serving cell belonging to the first network and to a second network and storing the measurement information,
storing information on the loads of neighboring cells of a subscriber's serving cell belonging to the first network,
storing information on the loads of neighboring cells of a subscriber's serving cell belonging to the second network,
if the neighboring cells of the serving cell in the first network are congested,
choosing a cell in the second network as a handover target cell,
giving a handover trigger,
performing a handover from the first network to a determined cell of the second network.

3. The method of claim 1, wherein the networks belong to different operators.

4. The method of claim 2, wherein the networks belong to different operators.

5. The method of claim 1, further comprising a handover trigger.

6. The method of claim 2, wherein measurements are handover measurements defined by the telecommunication system currently used.

7. The method of claim 2, wherein the handover trigger is a message sent by the network element collecting load information.

8. A telecommunication system, the system comprising at least two radio networks and at least one user terminal, the system further comprising,
a user terminal being served in a cell of a first network,
means for detecting the loads of cells in the first network,
means for detecting the loads of cells in a second network,
means for choosing a cell in the second network as a handover target cell,
means for performing a handover from the first network to the second network.

9. A telecommunication system, the system comprising at least two radio networks and at least one user terminal, the system further comprising,
a user terminal being served in a cell of the first network,
means for measuring on neighboring cells of a subscriber's serving cell belonging to a first operator's network
means for measuring on neighboring cells of a subscriber's serving cell belonging to a second operator's network,
means for detecting the loads of cells in the first network,
means for detecting the loads of cells in the second network,
means for choosing a cell in the second network as a handover target cell,
means for giving a handover trigger,
means for performing a handover from the first network to a determined cell of the second network.

10. The system of claim 8, wherein the networks belong to different operators.

11. The system of claim 9, wherein the networks belong to different operators.

12. The system of claim 8, further comprising means for generating a handover trigger.

13. The system of claim 9, wherein measurements are handover measurements defined by the telecommunication system currently used.

14. The system of claim 9, wherein the handover trigger is a message sent by the network element collecting load information.

15. A radio network controller comprising:
means for storing information on the loads of cells in a first network,
means for storing the information on loads of cells in a second network,
means for choosing as a handover target cell a cell in the second network,
means for controlling a handover from the network to which the radio network controller belongs to a different network.

16. A radio network controller, comprising:
means for storing information on the loads of cells in a first network,
means for storing the information on loads of cells in a second network,
means for choosing a cell in the second network as a handover target cell,
means for giving a handover trigger,
means for controlling a handover from the network to which the radio network controller belongs to a different network.

17. The radio network controller of claim 15, wherein the networks belong to different operators.

18. The radio network controller of claim 16, wherein the networks belong to different operators.

19. The radio network controller of claim 15, further comprising means for generating a handover trigger.

20. The radio network controller of claim 16, wherein the handover trigger is a message.
